(19) United States
(12) Patent Application Publication
(10) Pub. No.: US 2005/0043074 A1
(43) Pub. Date: Feb. 24, 2005

(54) Ghost-games grid board

(76) Inventor: Yehouda Harpaz, Cambs (GB)

Correspondence Address: BRIAN MUGELE, 4826 HAMBURG, ST. LOUIS, MO, 63123, US

(21) Appl. No.: 10/497,428

(22) PCT Filed: Mar. 31, 2003
(86) PCT No.: PCT/GB03/01399

(51) Int. Cl. A63F 13/00

(52) U.S. Cl. 463/9

(57) ABSTRACT

A boar is made of many points arranged in a grid on a flat surface, and connected to a game manager (a CPU+memory+software). Each grid point notifies the games manager when it is pressed, and the games manager can illuminate each grid point by one of the colours. The board moves a sound the grid a group of points in one colour, and the players try to touch it.

This invention relates to electronic board-games board for playing games in which a move is done by indicating a point on the board, and the state of the game is expressed in the state of the points. These games include traditional games like Go, but also large number of other potential games, puzzles and exercises. The invention presents a new kind of a set-up for a novel game to play on this board.

PCT/NL97/00589 (Golad 1997) describes a new kind of electronic board-games board, on which you play by touching a point. GB 9919551.3 (Farpaz 1999) and PCT/GB00/00460 tarpaz 2000) describe a variation of the idea. An effective way of implementing the hardware of the board was presented in PCT/GB01/03311 (Harpaz 2001). This board can be used to implement classic board games like Go and Reversi and similar games, but it also can be used to implement various other kinds of game, including fluid games, in which the board changes illumination of points not only when a player touches a point Fluid board games are a novel concept, with a very different “feel” from the existing board games, because they are less about analytical thinking and much more about speed of response and hand-eye coordination.

Several such fluid games where described GB 9919551.3. One of them describes the board moving the points about the board, and the players try to touch them. The invention which is describe here is the full implementation of this game.

In the description below, a point in the grid is neighbour of a second point if it is one of the closest points around the second point. In a square grid, this can mean either the closest four points or the closest eight points, and the invention here covers both possibilities. A continuous group of points is a group in which each pair of points is connected either by the two points being neighbours of each other or both being connected to a third point in the group.

According to the current invention, some of the games that are implemented on the board are variations of the novel game Ghost. The board needs three colours at each point for the Ghost game, and its behaviour is as follows:
Two colours are player-colours, and one is neutral.
The board keeps scores for the two player-colours;
The board switches on a continuous group of points in one of the player-colours (the Ghost), and changes the group position each short time interval which is smaller than 0.5 second, by switching on some unilluminated points which are neighbours of the group, and switching off some points of the group;
When one of the points in the group is touched, the board changes the score of one of the colours and changes the colour in which the group of points is illuminated to the other player-colour;
When an unilluminated point is touched, the board switches it on in the neutral colour, and changes the colour in which the group of points is illuminated to the other player-colour.

A specific embodiment of the invention will now be described.

The general structure of the board itself and the behaviour of the software is as described first in the GB patent application GB 9919551.3 and PCT/GB00/00460 and also in the priority document GB 0213454.2, and the actual implementation of the grid points is as described in the international application PCT/GB01/03311. However, the Ghost game requires three colours. This is achieved by using in each point two LEDs, one red and one green, which when they are switched on together give a yellow colour, and thus give three colours: red, green and yellow. The yellow is the neutral colour, and red and green are the player-colours. As described in GB9919551.3, in addition to the grid points, the board also has a control area with alphanumeric display and control buttons to change parameters, and two turn lights to mark which colour is currently playing. One of the turn lights is green, and the other is red.

When the game that is selected is Ghost, the software perform the steps below. Terms in italics signif parameters that the players can set.
1) Switch off all the points and set internally two variables to 0 (Scores for the two players). Display the Scores. make one of the player-colours the current colour. Set internal variable (Turns counter) to 0.
2) Switch on four continuous points in the current colour.
3) Switch the turn light of the current colour on, and switch the other turn light off.
4) Set an internal variable (Turn End) to the current time plus an interval (Twuz Time). The Turn Time will typically be several tens of seconds.
5) Set an internal variable (Next Move) to the current time plus a short interval (Gap). For healthy adults and children older than 8, 20-50 milliseconds seem to be an appropriate Gap. For younger children longer intervals, of few tenths of a second, are required. The players can set the Gap to fit their speed and mood.
6) Check if the current time is larger than the Next Move variable that was set in step 5. If so, select a point which is a neighbour of any of the points in the group, and check that it is unilluminated. If it is illuminated, try another point If no point which neighbours the group is unilluminated, go to step 10 (end the game). Once an unilluminated neighbouring point is found, switch it on in the current colour, and switch off one of the other points such that the group of points in the current colour is still continuous.
7) Check if some point was touched. If so:
   a) If the touched point is illuminated with the neutral colour, go back to step 6.
   b) If it is not illuminated, switch it on in the neutal colour and go to step 9.
   c) If it is illuminated increase the score of the current colour, and redisplay the scores. Go to step 9.
8) Check if the current time is bigger than the Turn End variable which was set in step 4. If not, go to step 6.
9) Switch the four points in the group to the other player-colour, and make the other player-colour the current colour. Increment the Turn Counter variable. Check if it reached the value Tun Limit (which will be typically set to several 10s). If it didn't, go to step 3.
10) Declare in the character display which colour won, based on the scores. Also display the number of turns that were played. This may be smaller than the Turn Limit if the game finished because the group is completely surrounded, so in step 6 the board cannot find a new point

With this behaviour, the players see a group of four points “running” around the board “at random” (repeated executions of steps 5-8), in the colour of the current player (which is indicated by the turn light (step 3)). The current player tries to touch any of this group of points (step 7). If they succeed their score increase. If they touch a point not in the group it becomes illuminated in the neutral colour, and the group does not go through it any more. After the player touches a point, or some interval (Turn Time) passed (step 8), the turn goes to the other player (Step 9). After a fixed number of turns (Turn Limit), or when the group is surrounded and cannot move anymore, the game ends (step 10) and the player with the larger score wins.

The way the game was described, when a point which is illuminated in the neutral colour is touched, the board ignores it. This behaviour may be changed such that in this case the board changes the current colour to the other colour. This behaviour seem to be less intuitive to the players, so the described behaviour is better.

With exactly the same behaviour, a single player can play trying to achieve high scores for both red and green. In addition, a single player can also play a different game, in which the task is to end the game in as small number of turns as possible. To achieve that, the player tries to surround the group with points in the neutral colour, until the group is completely surrounded. Then the board stops the game, and the player checks the number of turns to see how well he has done (ignoring what the board says in step 10 about who won). Surprisingly (at least for the inventor), this way of playing is almost as popular as the first way of playing.

Additional features that can make the games more attractive are:
a) The selection of point to add to the group (in step 6) can be completely random, but the game is more attractive if the group seem to be moving as if it has a head and a tail. To achieve this effect, the board first check if it can find an unilluminated point near the point that were added to the group last, and if it succeeds, adds it to the group (i.e. switches it on in the current colour) and switch off the point that was added first to the group. This gives the impression that the group has a head (last added point) and a tail (first added point). If the board cannot move the head, it looks for other possibilities.
b) Change the time between moves (gap) during the game, e.g. each turn (i.e. in step 9) increment or decrement it a little. The players will perceive it as a change in the speed of the group of points.
c) Add a delay between the turns, to prevent one player playing by mistake in the other player's time. This will be done in step 9, by first switching the turn light off and selecting the neutral colour, performing for a while (typically 0.5 seconds) steps 5 and 6 without performing steps 7 and 8, and then doing the switch to the other colour.
d) When a player succeeds to touch the group (step 7c), the board increases the player's score, but during the game the players concentrate on the game and find it difficult to look at the score. To tell the players when they succeed, the board can, apart from increasing the score, also give a feedback by displaying several (typically 4-10) different patterns of points (typically containing 12-24 points) in the current colour one after the other with some delay (typically 40-80 Milliseconds), and then switch all the points back to their state they were before the patterns where displayed. This strong visual feedback make it easy for the players to see when they succeeded.

Additional kinds of games can be added by relatively small changes to the behaviour of the board For example, in step 7, the board can give the player a score when the touched point is a neighbour of the group, no score when the touched point is some other unilluminated point, and give a score to the other player when the touched point is in the group. With this behaviour, the players try to achieve high score, by touching near the group but not the group itself. This requires better accuracy and judgement, and makes the game more interesting to more able players.

1) An electronic board-games board for playing games comprising a grid of grid points on a flat surface, where each grid point is a visible element which is capable of detecting when it is pressed, and can be illuminated in three different colours, where in at least one game the behaviour of the board is as follows:
two colours are player-colours, and one is neutral;
the board keeps scores for the two player-colours;
the board switches on a continuous group of points in one of the player-colours, and changes the group position each short time interval which is smaller than 0.5 second, by switching on some unilluminated points which are neighbours of the group, and switching off some points of the group;
when one of the points in the group is touched, the board changes the score of one of the colours and changes the colour in which the group of points is illuminated to the other player-colour;
when an unilluminated point is touched, the board switches it on in the neutral colour, and changes the colour in which the group of points is illuminated to the other player-colour.

2) A board as described as claim 1, in which when the touched point is one of the group, the board increases the score of the colour of the group.

3) A board as described in claim 1, in which when the touched point is one of the group, the board increases the score of the other player-colour, and if the touched point is unilluminated and is one of the neighbours of the group, the board increases the score of the colour of the group.

4) A board as described in claim 1, in which the board terminates the game after a pre-determined number of turns, and declares the colour with the larger score as a winner.
